(19) United States
(12) Patent Application Publication
(10) Pub. No.: US 2008/0215670 A1
(43) Pub. Date: Sep. 4, 2008

(54) TRACKING USAGE AND MONITORING USERS OF A DISTRIBUTED LEARNING SYSTEM

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,348

(22) Filed: Sep. 6, 2007

Related U.S. Application Data
(60) Provisional application No. 60/824,750, filed on Sep. 6, 2006.

(51) Int. Cl. G06F 15/16

(52) U.S. Cl. 709/203

(57) ABSTRACT

A system for monitoring and tracking the distribution of educational information in a distributed learning environment includes allowing a user to connect to a management system through a network connection. The management system transmits a plurality of educational material that may be used and operated on the user's computer when the user is offline. The management system performs a sync operation when the user is able to reconnect to the system. After each transfer and/or sync operation, the management system stores data associated with the outcome of the transfer and/or sync, wherein the data may be used to monitor a student's progression through a course and to track diagnostic problems in a user's computer.

### CROSS-REFERENCE TO RELATED APPLICATIONS

This application claims priority to U.S. Provisional Application Ser. No. 60/824,750, filed on Sep. 6, 2006, and is incorporated herein by reference in its entirety.

### BACKGROUND OF THE INVENTION

1. The Field of the Invention

The invention generally relates to online systems for educational course materials, and more particularly to systems for tracking the usage and monitoring the users of online courses in a distributed learning system.

2. The Relevant Technology

Web-based learning management systems (LMS) and content management systems (CMS) have been increasingly used by corporations, government agencies, and higher education institutions as effective and efficient learning tools. A LMS is a software package that facilitates the management and delivery of online content to learners, often in order to enable the individualized and flexible access to learning content. Typically, an LMS allows for an online teaching environment, which a CMS is a computer software system that is typically used to manage the storing, controlling, versioning, and publishing of the educational content. Using a combination of the above technologies, several educational systems have been developed in the art that offer flexible online learning solutions for educators.

Due to the flexible and individualized nature of the systems, students and employees can take courses on their own time and at their own pace, in accordance with their various daily commitments, while educators, management, and human resource departments are able to track progress. Further, because the systems may be easily updated and modified, the systems often provide more relevant information than is currently available using traditional teaching tools.

One advantage of these courses is the ability to give students key information they need outside the confines of the traditional university buildings or classrooms. The distance learning students can gain access to the course materials by connecting to the Internet or other global network. Thus, several institutions have implemented online or hybrid courses where the course is administered wholly or partially in the online setting.

Despite these advantages, however, these systems present problems when educators or students are traveling and cannot connect to the corporate LMS or online courses. Likewise, deployed troops have limited connectivity to courses in the field. Many students are on a tight budget and have slow or no connectivity when off campus. And faculty who want to continue to do their work when they are at an offsite event are unable to work when away from their network. Thus, the present systems are limited because they require constant access to the Internet or similar network connection.

Recently, distributed learning systems have been developed which allow users of the systems to continue working regardless of their network connectivity. Typically, such systems function by replacing the need to access content from a remotely located server and database with a system which stores a large amount of content locally on the user's computer. Because the content is stored locally in the user's computer, the user complete portions of the course and retrieve new content without sending requests to a remote server, meaning that the user may progress through the course without requiring a network connection.

One difficulty in using distributed online systems, however, is that it is often difficult to adequately track and monitor a user's progress or interaction with the system. Unlike traditional classroom environments where teachers can rely on consistent interaction with students to evaluate their progress, educators and administrators of distributed online systems may not realize that a student is falling behind in a course until it is time to calculate the final course grade. In addition, it is necessary in distributed online systems that system administrators are able to track and monitor the health of the users' computers to ensure that they are functioning properly. Thus there is a need for a system and method of tracking and monitoring user's usage and progress in a distributed learning environment.

### BRIEF SUMMARY OF THE INVENTION

The invention generally relates to online systems for educational course materials, and more particularly, to systems for monitoring and tracking the distribution and periodic synchronization of course information in a distributed learning environment.

One aspect of the present invention is a method for monitoring the distribution of the educational information. The method comprises allowing a user to connect a computing device to the educational management system server through a network connection, transferring a plurality of educational information from the educational management system to the computing device, performing a sync operation when the computing device is connected to the educational management system, and storing data associated with the outcomes of the transfer and sync operation of the plurality of educational information in the server. The plurality of educational information includes data and computer programs that are capable of performing computing functions in the computing device while not connected to the network.

Another aspect of the present invention is a second method for monitoring the distribution of the educational information. The method comprises allowing a user to connect a computing device to the educational management system server through a network connection, transferring a plurality of educational information from the educational management system to the computing device, storing data associated with the outcome of the transfer of the plurality of educational information, and displaying a report of the stored data associated with the outcomes of the transfer and sync operation of the plurality of educational information on a user's computer.

A third aspect of the present invention is a system for monitoring and tracking the distribution of educational information. The system comprises a plurality of user computing devices capable of connecting to an education management system via a network connection, and an education management system comprising a server capable of transferring and receiving a plurality of educational information with the user computing devices, and database capable of storing data associated with the outcome of the sending and receiving of educational information.

These and other aspects of the present invention along with additional features and advantages will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating an exemplary system capable of performing the invention;

FIG. 2 is a block diagram illustrating a method of distributing and receiving educational content from a user of a distributed learning system;

FIG. 3 is a block diagram illustrating the method of the invention in a networked computing system;

FIG. 4 is an exemplary user interface illustrating a monitoring report for an educator;

FIG. 5 is an exemplary user interface illustrating a monitoring report for an distributed learning system administrator; and

FIG. 6 is an exemplary user interface showing a report for a system's administrator.

### DETAILED DESCRIPTION OF THE VARIOUS EMBODIMENTS

The principles of the various embodiments are described using the structure and operation of examples to illustrate the present invention. The various embodiments provide the capability to utilize the online courses with no or intermittent Internet access and enables the periodic synchronization of information, such as course materials, tests, bulletin boards, grade books, quizzes, discussion threads, message boards, and the like.

As used herein, the term “user” may be used to describe students, employees, content providers, educators, employers, or course administrators who are accessing the education management system using a computer. The computer may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

In each case, the distributed nature of the system used in association with the present invention allows the various users to utilize aspects of the educational system while offline, meaning that the users may continue working regardless of their present interconnectivity. As discussed more specifically below, the system operates by distributing various learning software onto the user computer when the user is connected to the system, wherein the learning software continues being used when the user is no longer connected to the system. Later, when the user connects to the system, the user's computer and the educational system perform a syncing operation. During the syncing operation, the educational system receives any work or new data that has been created or modified while the user's computer was offline and the user's computer receives any new information or data available on the educational system.

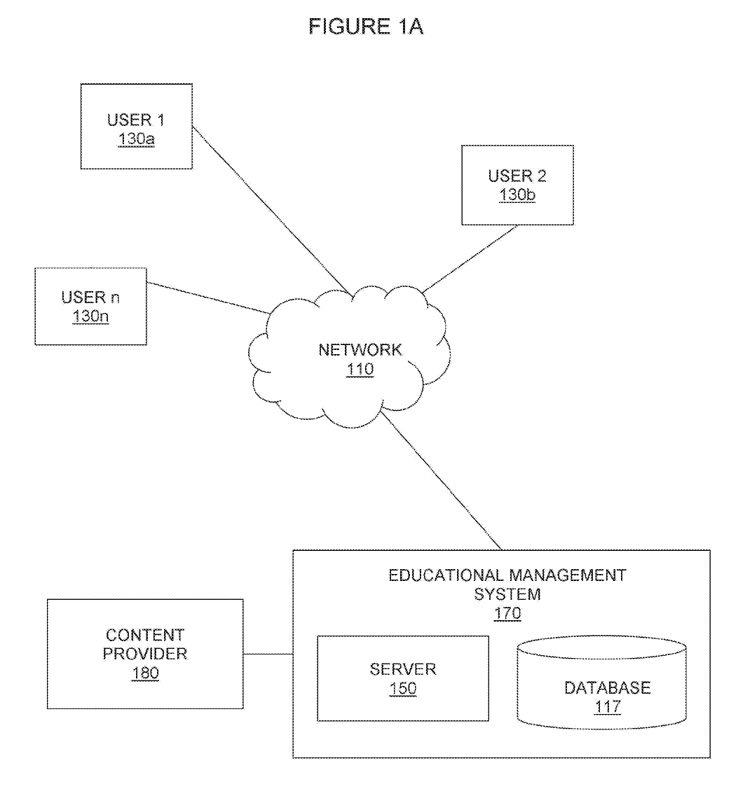

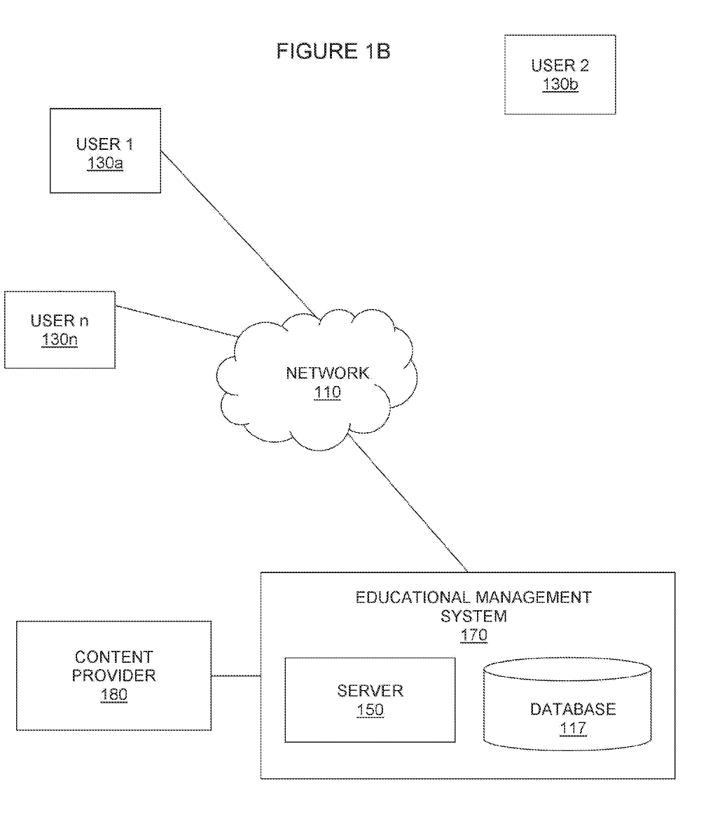

FIG. 1A is a block diagram illustrating an exemplary system capable of performing the present invention. As shown, the system includes a number of users, “User 1” 130a through “User n” 130n, who are connected to an educational management system 170 via a network connection 120. As will be understood by one of ordinary skill in the art, the network 120 may be any local or global network, including a LAN, WAN, wireless network, internet connection, and the like.

In one embodiment of the invention, the education management system 170 includes a server 150 capable of sending and receiving communications and data via the network 120, along with a database 160 capable of storing a plurality of educational software and data. In addition, the database 160 can be used to store data relating to the user identification. As will be understood by one of ordinary skill in the art, any number of configurations may be used to create an education system, including systems using a series of interconnected databases, computers, and servers.

In this example, the education management system 170 is connected to a content provider 180. Here, the content provider 180 may be a third party content provider, who is responsible for creating various course software. In contrast, the content provider 180 may be part of the education management system 170. Further, the content provider 180 may be an educator or course developer who connects to the education management system 170 as a user.

According to one embodiment of the present invention, the system may use a mechanism such as BitTorrent or related protocol wherein the system may use a peer-to-peer communications protocol to share the educational content. Using such systems, the system typically breaks down any content into a number of smaller, identically-sized pieces, which are distributed among a plurality of users of the system who require the educational content. Then using a series of P2P connections, the files may be sent and received by the users over a period of time. Advantageously, this method of distribution is capable of distributing large amounts of data widely without requiring the content provider 180 or server 150 to incur the large costs of hardware, hosting, and bandwidth resources that would otherwise be required to distribute the educational content. Further, this embodiment would allow the “trickling” of downloads, meaning that in situations where the content to be downloaded is a large file, the system may permit the user to download smaller discrete portions of the content, instead of requiring a constant connection for the duration of the downloading process. A scheduled download can populate the user's computers with course content over a controlled distribution.

In situations where a large number of identical files need to be distributed to a number of users of the system, such as at the beginning of a semester or session, when each student of the program requires the content associated with the course, the present invention may be effectively distributed without overwhelming the education management system 170.

FIG. 1B illustrates the ability of the present invention to be used when a user, here “User 2” 130b is no longer connected to the education management system 170. As described more fully below, one advantage of the present invention is the ability to transfer or distribute software and/or data onto “User 2's” 130b computer which enable “User 2” 130b to continue using the educational software when the computer is not connected to the management system 170. According to the invention, when “User 2” 130b later establishes a connection with the educational management system 170, such as the connection shown in FIG. 1A, the system 170 will perform a syncing operation, wherein it will send and receive data from the “User 2” computer 130b until both the system 170 and the “User 2” 130b have updated information.

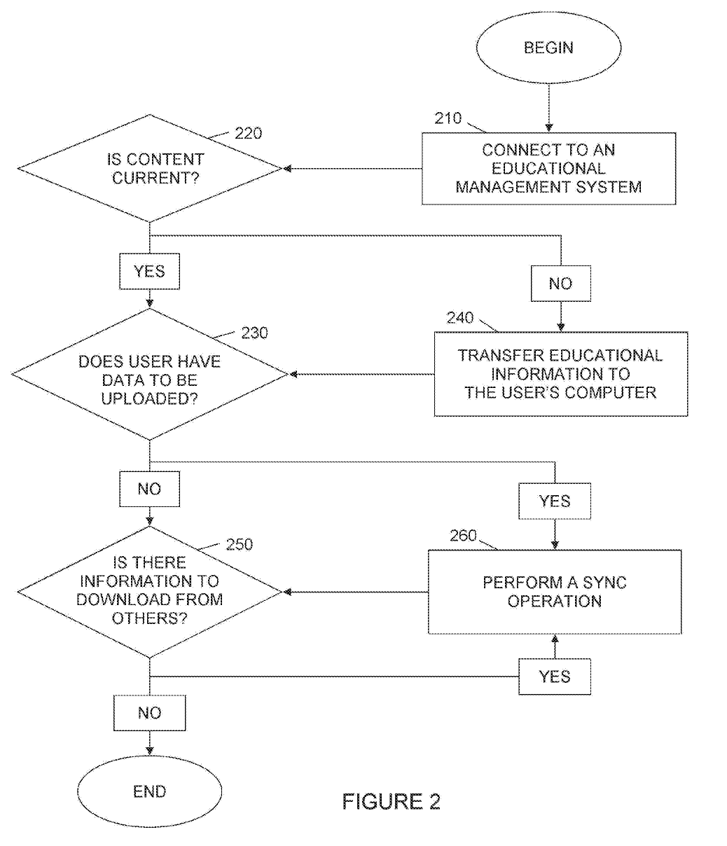

FIG. 2 is a block diagram a method for transferring and syncing the educational content a networked computer environment. At step 210, a user operating a computing device connects to the education management system through a network connection after being verified, for example, by a password and user ID. Optionally, this may involve an authentication process wherein user identification information is sent to the system to gain access to the system. At step 220, the system determines whether the educational content and information on the user's computing device is current. If the user's content is not current, then at step 240, the system transfers a plurality of educational information to the user, and continues to step 230. According to the invention, the educational information includes data and software that is capable of performing various functions regardless of connectivity to the system. Examples of data and software that may be transferred is described more fully below.

Returning now to FIG. 2, if at 220 the system determines that the user's computing device has current content, then at step 230 the system determines whether the user has data or educational information on the computing device that needs to be uploaded to the education management server. If at step 230 the system determines that the user's computer has data that needs to be uploaded, then at step 260 the system performs a sync operation and continues to step 250. If at step 240 the system determines that the user's computer does not need to upload content onto the education management system, the system continues to step 250, where the system determines if the user's computer requires any educational content that needs to be downloaded from other users of the system. If so, then at step 260, the system performs a sync operation with the other user's computer, and returns to step 250 to determine if the user's computer requires any additional content from other users. This process continues until the system determines that there is no more educational content that needs to be downloaded from the system or other users connected to the system, wherein the transfer process ends.

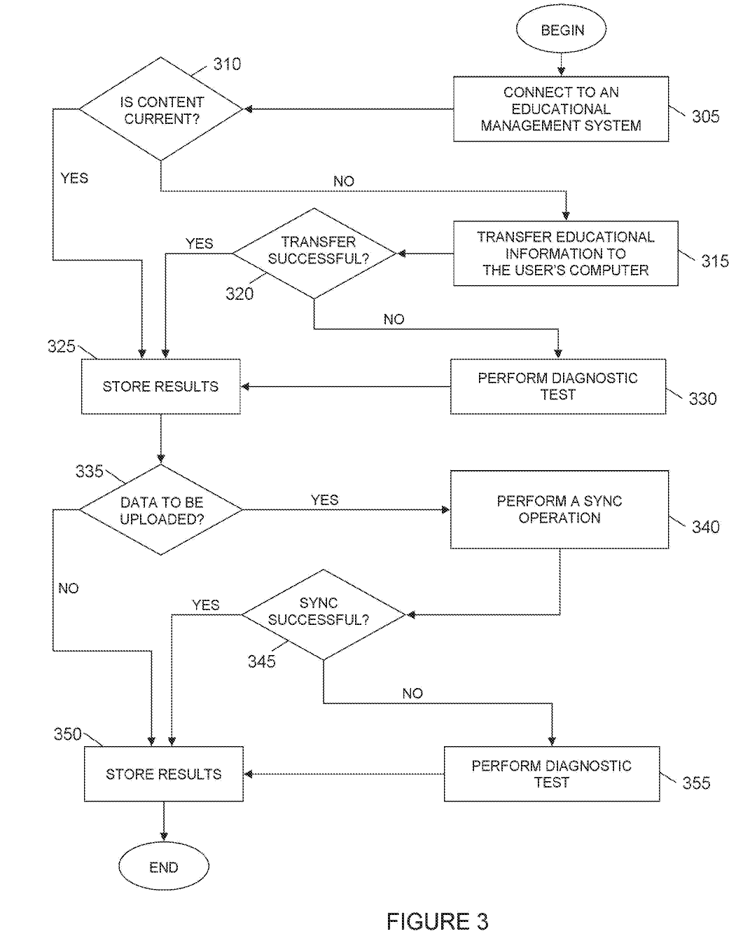

FIG. 3 illustrates the monitoring and tracking aspects of the invention in association with the transfer and syncing operations illustrated in FIG. 2. At step 305, the user operating a computing device is permitted to connect to the educational management system after being verified, for example, by a user ID and password. At step 310 the system determines whether the content on the user's computing device is current. If the content is current, then the system proceeds to step 325, where the system stores the results of the inquiry at step 310. If, however, the system determines that the content is not current, then the system initiates the transfer of educational information to the user's computing device at step 315. After initiating the transfer, then at step 320 the system then determines whether the transfer completed successfully. If the transfer was successful, then the system proceeds to step 325, where the system stores the results of the successful transfer. If at step 320 it is determined that the transfer was unsuccessful, then at step 330 the system initiates a diagnostic test on the user's computer. After the diagnostic test is complete, the system proceeds to step 325 where the results of the failed transfer and diagnostic test are stored.

After the results are stored at step 325, then at step 335 the system determines whether there is data on the user's computer that needs to be uploaded to the education management system. If not, then the system proceeds to step 350, where the results of the determination are stored. In contrast, if it is determined at step 335 that there is data to be uploaded, then the system performs a sync operation at step 340. Following the sync operation at step 340, the system determines whether the sync was successful at step 345. If the sync was successful, then system proceeds to step 350 where the results of the successful sync are stored. If the sync was not successful, then at step 355 the system performs a diagnostic test to determine why the sync was not successful. After the diagnostic test is complete, the system proceeds to step 350 where the results of the failed transfer and diagnostic test are stored.

As understood by one of ordinary skill in the art, the diagnostic test may perform any number of evaluations and/or tests on the user's computing device including but not limited to scanning for viruses, checking for disk space, performing disk cleanup operations, error detection, monitoring network connectivity, testing hardware/software performance, and the like. Once the diagnostic test is performed on the user's computer, the results may be sent to the education management system for review and analysis to determine why the transfer or sync operation failed.

Since the diagnostic test is initiated by the education management system, one advantage of the present invention is that is allows system administrators to assist users remotely, by giving them meaningful and accurate data relating to the user's computer without requiring the user to initiate each test and report its results. Similarly, one advantage of the present invention is that it does not require the user to have a vast amount of computer experience since the diagnostic tests are initiated, stored, and evaluated by the education management system.

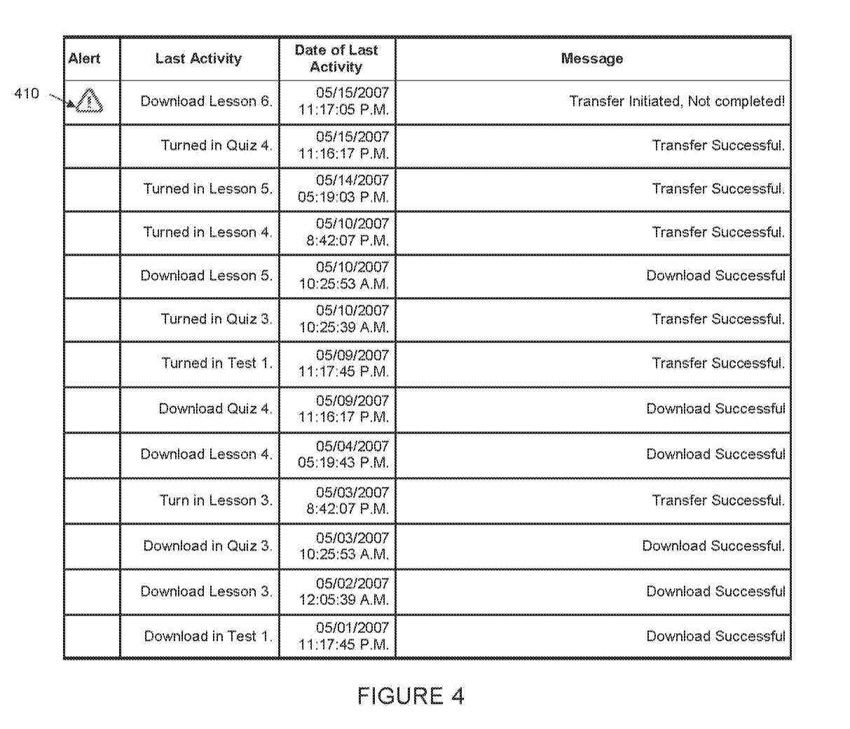

According to an embodiment of the system, the stored information relating to the outcomes of the transfer and sync operations may be used to generate reports that may be displayed to various users of the education management system. For instance, FIG. 4 illustrates an exemplary user interface of a report that a student may receive that indicates the various transfer and receipt of data with the education management system. Using this report, the student may be able to confirm that his or her files have been successfully received from and uploaded to the system. Further, the user can review the date and time that he or she last connected to the system. In this example, the report includes an alert 410 notifying the user that “Lesson 6” initiated a download but failed to successfully complete. Thus, the user is notified of any difficulties sending and receiving content from the system.

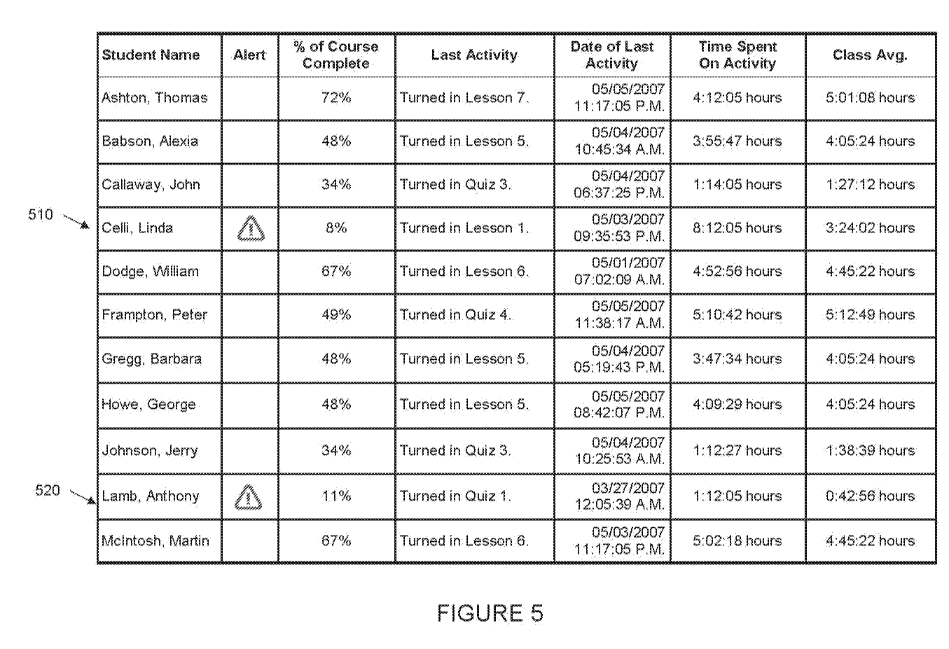

FIG. 5 illustrates an exemplary user interface of a report that a teacher or other educator may receive which lists the latest course work that has been received by the system. As understood by one of ordinary skill in the art, the report may include a variety of information. Here the report can include a listing of students with a field indicating their progress through the course, their last turned in course work, the date it was turned into the system, the amount of time the student spent working on the activity, and/or a comparison field indicating the average amount of time spent on that activity by other students in the course. Using this comparison data, the report may include an alert, such as the alert 510 for student “Linda Celli” indicating that Linda spent 5 hours longer on the assignment that the average student in the course, which may indicate that she is struggling with the material covered in Lesson 1 and needs additional assistance. Similarly, the system may include an automatic alert 520 for any student who has not turned in any coursework for a predetermined period of time such as the example shown for “Anthony Lamb.”

As understood by one of ordinary skill in the art, any number of alert, warning, or detection systems may be used to indicate that a student is not adequately progressing in a course. Here the comparison of amount of time spent on each activity and the last time the student turned in coursework are merely two examples of alerts that may be used in connection with the reporting mechanism used in association with the present invention.

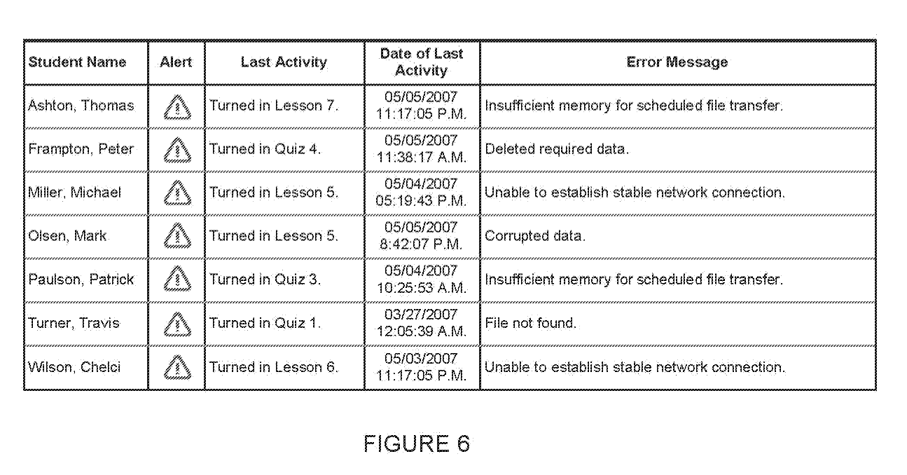

FIG. 6 is an example of a user interface showing a report that a system's administrator may receive. Here the report includes the outcome of the diagnostic test that was performed as previously discussed. Advantageously, the system administrator is given a report of the various system errors that exist in the users' computers so that the system administrator is able to efficiently diagnose the problem and restore the user's ability to use the education management system.

An error message, for example, stating that the user was “unable to establish a stable network connection” may indicate that the modem in the user's computer has failed, or that there is an insufficient network connection to perform the transfer. Similarly, a “file not found” or “deleted required data” may indicate that the user has deleted data that the system needs to operate successfully. Thus, the system administrator may install new equipment or initiate a new file transfer to remedy the respective errors without wasting time trying to determine what is wrong with each computer by personally initiating a diagnostic test and inspection of the computer.

As illustrated in FIGS. 4-6, the system may generate reports that include the outcome of the transfer and sync operations together with the results of the diagnostic test, if any, to a variety of users. One aspect of the invention, however, is the ability to use the stored outcome to generate individualized reports that are meaningful to various users of the system. For example, the educators are given information relating to the student's progress through the course, without giving them information relating to the diagnostic or errors of each of their students, allowing the educators to focus their attention to the education of their students. At the same time, the system administrator is not given excess detail related to the content of the course work, and only receives reports indicating diagnostic errors for users of the system. Similarly, the student receives a report that only reports information that will be meaningful and relevant to the student, without bogging him or her down or overwhelming them with technical information.

Accordingly, one aspect of the invention is the ability to generate individualized reports to various users based on the outcome stored in the education management system. Using this information and the reports, the users of the system may effectively monitor and track the distribution and transfer of content in the system. This allows teachers, students, and system administrators to monitor their computer's health and their personal progression through the duration of the course.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above examples should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment including an educational management system comprising a server and educational information connected to a plurality of user computing devices, each user computing device having a user identification, a method for monitoring the distribution of the educational information, the method comprising:
verifying the user identification;
connecting a user computing device to the educational management system server through a network connection after verifying the user identification;
transferring a selection of educational information from the educational management system to the computing device;
obtaining the status of the transferred information;
performing a sync operation between the educational management system and the computing device;
obtaining the status of the sync operation; and
storing data associated with the status of the transfer and sync operation of the plurality of educational information in the server;
wherein the plurality of selected educational information includes data and executable processes that are capable of performing computing functions in the computing device while not connected to the network.

2. The method of claim 1, wherein storing the data associated with the status of the transfer and sync operation comprises sending a copy of the stored data to the educational management server.

3. The method of claim 2, wherein the method further comprises analyzing the copy of the stored data and generating a report of the stored data associated with the outcomes of the transfer of the plurality of educational information and sync operation on a user's computer.

4. The method of claim 1, wherein the educational information and computer programs comprise course content, assignments, grade books, discussion threads, message board updates, or assessments.

5. The method according to claim 1, further comprising displaying the report of the stored data associated with the outcomes of the transfer of the plurality of educational information and sync operation on a user's computer.

6. The method according to claim 1, wherein the user is at least one of the following: a student, an educator, a course administrator, educational information provider, employer, or employee.

7. The method according to claim 1, wherein the stored data associated with the outcomes of the transfer of the plurality of educational information and sync operation on a user's computer comprises data related to a user's progress through an online course, computer diagnostic data related to a user's computer, and data relating to the date and time of the last successful sync or transfer with the educational system.

8. The method according to claim 7, wherein the computer diagnostic data comprises error reporting data, virus detection data, analysis of hardware and software performance, and/or data related to the amount of available disk space on a user's computer.

9. In a computing environment including an educational management system comprising a server and educational information connected to a plurality of user computing devices, each user computing device having a user identification, a method for monitoring the distribution of the educational information, the method comprising:
verifying the user identification;
connecting a user computing device to the educational management system server through a network connection after verifying the user identification;
transferring a selection of educational information from the educational management system to the computing device;
obtaining the status of the transferred information; and
storing data associated with the status of the transfer operation of the plurality of educational information in the server;
wherein the plurality of selected educational information includes data and executable processes that are capable of performing computing functions in the computing device while not connected to the network.

10. The method of claim 9, wherein the educational information and computer programs comprise course content, assignments, grade books, discussion threads, message board updates, or assessments.

11. The method according to claim 9, wherein the user is at least one of the following: a student, an educator, a course administrator, educational information provider, employer, or employee.

12. The method according to claim 9, wherein the stored data associated with the outcomes of the transfer of the plurality of educational information and sync operation on a user's computer comprises data related to a user's progress through an online course, computer diagnostic data related to a user's computer, and data relating to the date and time of the last successful sync or transfer with the educational system.

13. The method according to claim 12, wherein the computer diagnostic data comprises error reporting data, virus detection data, analysis of hardware and software performance, and/or data related to the amount of available disk space on a user's computer.

14. A system for monitoring and tracking the distribution of educational information, the system comprising:
a plurality of user computing devices capable of connecting to an education management system via a network connection; and
an education management system comprising a server capable of transferring and receiving a plurality of educational information with the user computing devices, and database capable of storing data associated with the outcome of the sending and receiving of educational information;
wherein the plurality of educational information includes data and computer programs that are capable of performing computing functions on the user computing devices when the user computing devices are not connected to the education management system via the network.

15. The system of claim 14, wherein the server of the education management system is further capable of initiating and receiving the results of a diagnostic test in the user computing devices and the database is capable of storing the outcome of the diagnostic test.

16. The system of claim 14, wherein the educational information and computer programs comprise course content, assignments, grade books, discussion threads, message board updates, or assessments.

17. The system according to claim 14, wherein the stored data associated with the outcomes of the transferring and receiving of the plurality of educational information with a user's computer comprises data related to a user's progress through an online course, computer diagnostic data related to a user's computer, and data relating to the date and time of the last successful transfer and/or receipt of educational information with the educational system.

18. The system according to claim 18, wherein the computer diagnostic data comprises error reporting data, virus detection data, analysis of hardware and software performance, and/or data related to the amount of available disk space on a user's computer.

19. The system according to claim 14, wherein the server of the education management system is further capable of generating a report of the stored data associated with the outcomes of the transfer and receipt of the plurality of educational information and the user's computing device is capable of displaying the report.
